(19) United States
(12) Patent Application Publication
(10) Pub. No.: US 2013/0049693 A1
(43) Pub. Date: Feb. 28, 2013

(54) BATTERY POWERED ELECTRIC GENERATOR

(71) Applicant: PRASHANT RAM, Lakeview, OR (US)

(72) Inventor: PRASHANT RAM, Lakeview, OR (US)

(21) Appl. No.: 13/220,523

(22) Filed: Aug. 29, 2011

(51) Int. Cl. H02J 7/00

(52) U.S. Cl. 320/128

(57) ABSTRACT

A battery powered electric generator system and method of recharging a battery are disclosed. The system may include a battery, an inverter, and a charger connected between the battery and inverter. The charger may be adapted to draw and supply a portion of current drawn from the battery into the inverter back into the battery.

### BACKGROUND OF THE INVENTION

The present invention generally relates to power supplies, and more particularly, to a battery powered electric generator.

The continual advent of technological gadgets and machines powered by electricity places an increased load on the lifespan of electronic fuel sources. Consumers may expect power supplies to provide increased power and yet, maintain fuel lifespan. Additionally, emergency power supplies such as conventional battery-powered generators employed during a grid power outage or used in remote locales may drain prematurely over extended usage.

As can be seen, there is a need for a system that provides extended lifetime in a battery powered electric generator.

### SUMMARY OF THE INVENTION

In one aspect of the present invention, a battery powered electric generator system comprises a battery, an inverter connected to the battery adapted to supply converted current from the battery to a load, and a charger connected to the inverter and the battery. The charger may be configured to receive current from the inverter and supply said received current back into the battery.

In another aspect of the present invention, a method of recharging a power supply, includes drawing a current from a battery through a AC to DC inverter; supplying a portion of the current in the inverter into a charger; and supplying the portion of the current in the charger back into the battery.

These and other features, aspects and advantages of the present invention will become better understood with reference to the following drawings, description and claims.

### BRIEF DESCRIPTION OF THE DRAWINGS

FIG. 1 is a front perspective view of a battery powered electric generator system according to an exemplary embodiment of the present invention; and

FIG. 2 is a schematic diagram of the battery powered electric generator system of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims. Various inventive features are described below that can each be used independently of one another or in combination with other features.

Broadly, embodiments of the present invention generally provide a self-recharging power source that recharges a battery powering a load and drains the battery at a lower rate than conventional batteries.

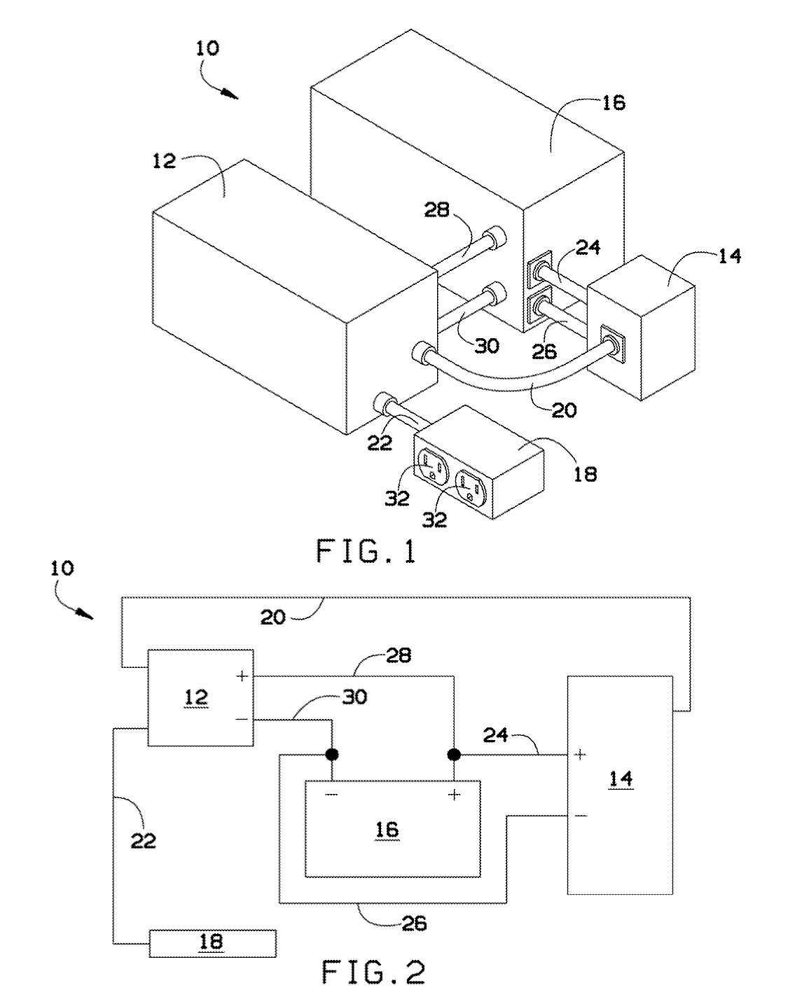

Referring now to FIGS. 1 and 2, a battery powered electric generator system 10 includes a DC to AC inverter 12, a battery charger 14, and a power supply or battery 16. The battery 16 may be a two terminal marine starting battery. The inverter 12, charger 14, and battery 16 may be connected together by conventional conduits. In an exemplary embodiment, the generator system 10 may also include a power strip 18 configured to receive electrical coupling of a load (not shown). The power strip 18 may include, for example, one or more electrical outlets 32. While three-prong AC outlets are shown, it will be understood that the outlets 32 may be adapted according to a load application. The power strip 18 may be connected to the inverter 12 by a power strip cord 22. The inverter 12 may be connected to the battery 16 via positive and negative inverter connections 28 and 30. The battery 16 may also be connected to the charger 14 via positive and negative charger connections 24 and 26. The charger 14 may also be connected to the negative terminal connection of the inverter 12. Grounding may comprise a grounding plate (not shown), serving as a base for all the components. The grounding plate sits on an earth ground.

In an exemplary method of operation by a user, the battery 16 may operate as the source of power for a load (not shown) plugged into an outlet 32 by the user. Current may be drawn from the battery 16 to the inverter 12 via positive and negative inverter connections 28 and 30 where the current is converted from DC to AC. AC may then be drawn to the outlet 32 available for connected loads (not shown), for example, appliances. A portion of the current in the inverter 12 may be converted to AC and may also be drawn back into the battery charger 14 via a battery charger cord 20. It will be understood that the cord 20 is connected to both the positive and negative elements of the circuit shown. Current in the charger 14 may then be fed back into the battery 16 slowly recharging the battery 16 during operation of the generator system 10.

It should be understood, of course, that the foregoing relates to exemplary embodiments of the invention and that modifications may be made without departing from the spirit and scope of the invention as set forth in the following claims.

What is claimed is:

1. A battery powered electric generator system, comprising:
a battery;
an inverter connected to the battery and adapted to supply converted current from the battery to a load; and
a charger connected to the inverter and the battery, wherein the charger is configured to receive current from the inverter and supply said received current back into the battery.

2. The battery powered electric generator system of claim 1, further comprising an outlet connected between the inverter and the load.

3. The battery powered electric generator system of claim 1, wherein the battery is a two terminal marine starting battery.

4. A method of recharging a power supply, includes:
drawing a current from a battery through a DC to AC inverter;
supplying a portion of the current in the inverter into a charger; and
supplying the portion of the current in the charger back into the battery.
